(19) United States
(12) Patent Application Publication
(10) Pub. No.: US 2005/0155068 A1
(43) Pub. Date: Jul. 14, 2005

(54) Multi-media player

(76) Inventor: Chung L. Chang, Diamond Bar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/754,357

(22) Filed: Jan. 8, 2004

(51) Int. Cl. H04N 7/18

(52) U.S. Cl. 725/75

(57) ABSTRACT

A multi-media player includes an enclosure, a video display, a digital media reader, a DVD player, a tuner, and a switch assembly. The video display is configured to receive data on at least one of a plurality of inputs and to display images represented by the received data. The digital media reader has a first output and is located substantially within the enclosure. The DVD player has a second output and is located substantially within the enclosure. The switch assembly has a plurality of connections between the plurality of inputs and the first output, the second output, and a third output of the tuner. The switch assembly also has a selector circuit that is configured to select at least one of the plurality of connections to transmit at least an image to the video display.

### BACKGROUND OF THE INVENTION

1. Field of the Invention

This application is directed to a vehicle mountable multi-media player that is capable of receiving data and displaying images represented by the received data.

2. Description of the Related Art and Summary of the Invention

Audiovisual systems for vehicles have been commonplace aboard commercial aircraft and motor coaches for some time. Such systems have also been incorporated into automobiles. For example, U.S. Pat. No. 5,775,762 to Vitito discloses a monitor that can be mounted to the ceiling of an automobile. However, the entertainment options offered this and other similar devices are limited to video display, such as from a video cassette player. These systems are not compatible with products, such as digital cameras.

Digital cameras enable quick acquisition of images in a digital format to be viewed on the camera and subsequently processed in a number of ways. For example, images may be viewed on a small screen on the camera and, if not suitable, deleted immediately. Or, the camera may be connected to a television so that the photographer can view or display the digital images. Cameras are also being equipped with the capability of recording relatively short video segments. These segments may be viewed later by connecting the camera to a television.

Although mobile, digital cameras are not well suited for displaying photographs because the monitor screens on cameras are too small to allow meaningful viewing or display of the images. While cameras may be connected to a television, such connection is not convenient for mobile environments, such as within an automobile. Therefore, digital camera users often go home to view the video clips and to select images to be kept and those to be discarded.

In one embodiment, a multi-media player capable of being mounted within a vehicle is provided. The multi-media player desirably includes an enclosure, a video display, a digital media reader, a DVD player, a tuner, and a switch assembly. The enclosure has a mounting surface that is configured to be mounted on an inside surface of a vehicle. The video display is configured to receive data on at least one of a plurality of inputs and to display images represented by the received data. The digital media reader includes a receptacle configured to receive a memory card. The digital media reader also includes a reader circuit configured to read digital data representative of at least an image from the received memory card. The digital media reader also includes at least a first output configured to transmit such read digital data. The digital media reader is located substantially within the enclosure. The DVD player has a receptacle configured to receive a digital video disc and a DVD reader. The DVD reader is configured to read digital data representative of at least an image from the digital video disc. The DVD player also has at least a second output that is configured to transmit such read digital data. The DVD player is located substantially within the enclosure. The tuner has a television receiver configured to receive data representative of at least an image encoded within a selected broadcast video signal and at least a third output configured to transmit such received data. The switch assembly has a plurality of connections between the plurality of inputs and the first output, the second output, and the third output. The switch assembly also has a selector circuit that is configured to select at least one of the plurality of connections to transmit at least an image to the video display.

### BRIEF DESCRIPTION OF THE DRAWINGS

These and other features, aspects and advantages of the present invention will be better understood with reference a preferred embodiment, which is illustrated in the accompanying drawings. The illustrated embodiment is merely exemplary and is not intended to define the outer limits of the scope of the present invention. The drawings of the illustrated arrangement comprise twelve figures.

FIG. 1 is a side view of a car with one embodiment of a multi-media player mounted on an inside surface thereof.

FIG. 2 is a section view of the car of FIG. 1 showing the multi-media player.

FIG. 3 is a perspective view of the multi-media player of FIG. 1 with a video display thereof shown in a stowed position.

FIG. 4 is a trailing end view of the multi-media player of FIG. 1 with a video display thereof shown in the stowed position.

FIG. 5 is a trailing end view of the multi-media player of FIG. 1 with a video display thereof shown in a deployed position.

FIG. 6 is a bottom view of the multi-media player of FIG. 1 with a video display thereof shown in the stowed position.

FIG. 7 is a bottom view of the multi-media player of FIG. 1 with a video display thereof shown in a deployed position.

FIG. 8 is a partial bottom view of the multi-media player of FIG. 1 with a video display thereof shown in a deployed, rotated position.

FIG. 9 is a right side view of the multi-media player of FIG. 1 illustrating one location where access may be provided to a digital media reader.

FIG. 10 is a leading end view of the multi-media player of FIG. 1 showing access to a digital media reader at one location.

FIG. 11 is a top view of the switching assembly, the digital media reader, and the DVD player within an open enclosure of the multi-media player of FIG. 1 according to an embodiment.

FIG. 12 is a functional block diagram illustrating components of the multi-media player of FIG. 1 and interactions among the components that enable viewing of a wide-variety of video sources and formats within a vehicle

FIG. 13 is a top view of one embodiment of a remote control for transmitting commands to the audio and video sources connected to the multi-media player of FIG. 1.

### DETAILED DESCRIPTION OF THE PREFERRED EMBODIMENT

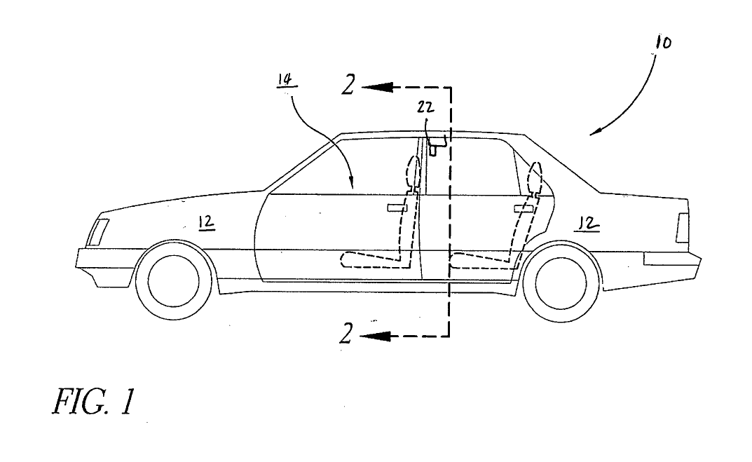

With reference now to FIG. 1, a car featuring certain features, aspects and advantages of the present invention will be described. The car, indicated generally by the reference numeral 10, is an environment for which many features, aspects and advantages of the embodiments described herein have been specially adapted. As used herein “car” is a broad term and is used in its ordinary sense and refers, without limitation, to any personal land transportation vehicle, e.g., a passenger automobile, a truck, a van, a mini-van, a sport-utility vehicle, etc. Nevertheless, certain features, aspects and advantages of the embodiments described herein can be used with other vehicles.

The car 10 generally comprises a chassis to which a body having a plurality of body panels 12 is attached. A passenger compartment 14 is defined by the body. A dashboard 16 preferably is positioned within the passenger compartment 14. The dashboard 16 usually is coupled with the chassis of the car 10 and houses several components of the car 10, e.g., a car radio 18. A vehicle roof 20 may form a portion of the chassis or may be coupled therewith. In various embodiments, a multi-media player 22 is provided within the passenger compartment 14. The vehicle roof 20 is one surface of the passenger compartment 14 that is well suited for mounting a multi-media player 22 because the elevated position enables the presentation of programming to multiple passengers within the passenger compartment 14. Of course, the multi-media player 22 may be mounted other surfaces, such as to a headrest. Further details related to mounting a monitor in a headrest may be found in U.S. Provisional Patent Application No. 60/451,232, filed Feb. 28, 2003, which is hereby expressly incorporated by reference herein in its entirety.

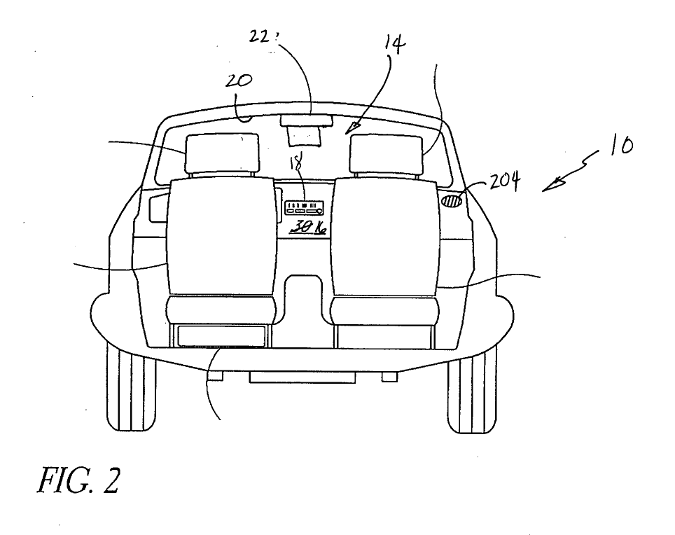

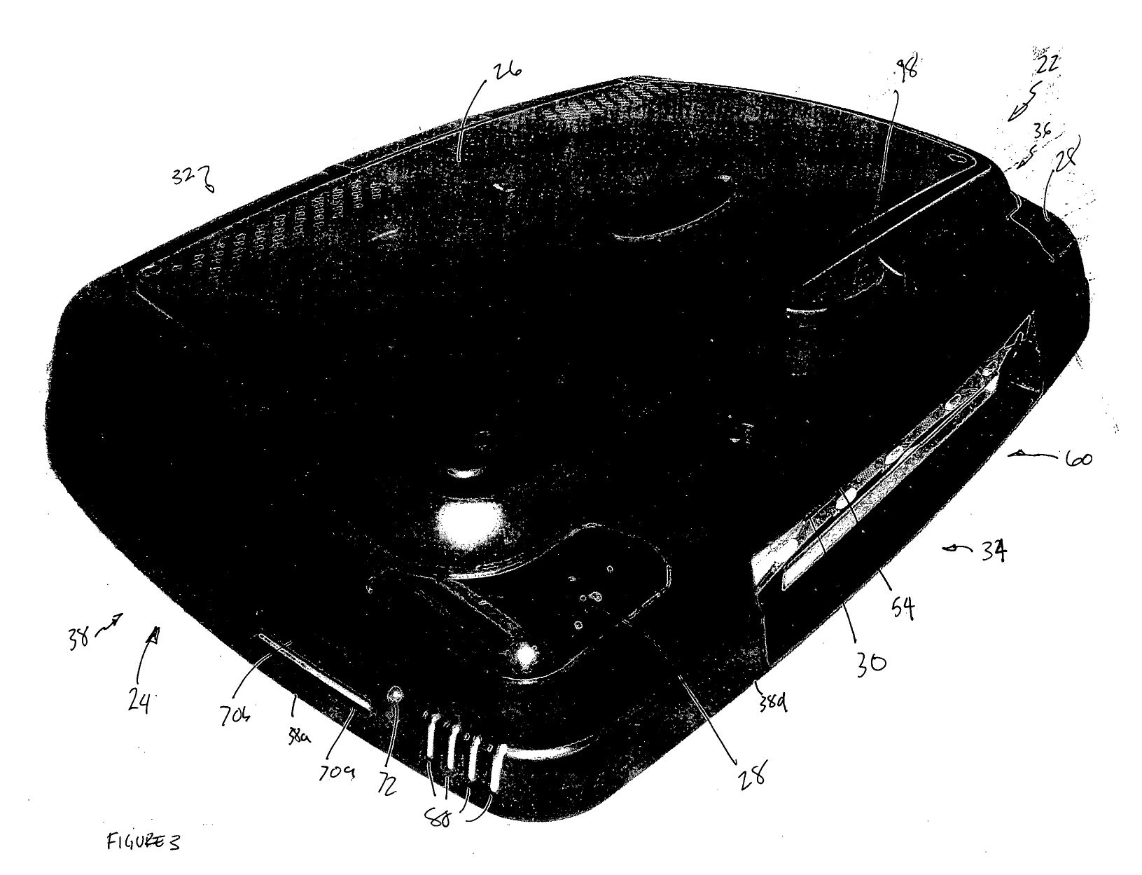

Referring to FIGS. 2-3, the multi-media player 22 includes an enclosure 24 and a video display 26. Preferably the video display 26 is coupled to the enclosure 24 by a hinge, discussed below. The enclosure 24 houses a variety of components or devices configured to transmit data representative of at least an image to the video display 26, as is discussed below. The enclosure 24 may be made of any suitable material and may be manufactured by way of any suitable process. For example, the enclosure 24 can be manufactured by an injection molding process using a suitable polymer.

The enclosure 24 may also house a variety of auxiliary components. For example, the enclosure 24 may house one or more lights 28 to illuminate the passenger compartment 14 as required by the passenger. In one embodiment, a multi-position switch 30 is provided to control the operation of the lights 28. The multi-position switch 30 operates in a manner similar to a dome light in a car. For example, the multi-position switch 30 can be moved from a first position where the lights are always on, to a second position where the lights are always off, and further can be moved to a third position where the lights come on when a door of the car 10 is opened.

The enclosure 24 has a leading end 32 and a trailing end 34. The leading end 32 is the end that generally faces forward when the multi-media player 22 is mounted in the car 10. The trailing end 34 is the end that is generally faces rearward when the multi-media player 22 is mounted in the car 10. The enclosure 24 also has a left-facing lateral side 36 and a right-facing lateral side 38. The left-facing lateral side 36 is the side of the enclosure 24 that faces to the left, or driver's, side of the car 10 when the multi-media player 22 is mounted in the car 10. The right-facing lateral side 38 is the side of the enclosure 24 that faces to the right, or passengers', side of the car 10 when the multi-media player 22 is mounted in the car 10.

Each of the left and right-facing lateral sides 36, 38 and the leading and trailing ends 32, 34 define an edge 38a, 38b, 38c, 38d that cooperate to define a mounting plane and which circumscribes a mounting surface 40 of the vehicle roof 20. The mounting surface 40 corresponds to the surface of the vehicle roof 20 that directly abuts the enclosure 24 when the enclosure is mounted thereto. The edges 38a, 38b, 38c, 38d will be referred to herein as being on the top, or the upper, surface of the enclosure 24, i.e., will be referred to from the perspective of the enclosure 24 as it is mounted in a vehicle. However, as discussed above, modifications within the scope of the claims set forth below may be made that permit the multi-media player 22 to be mounted in other orientations.

In one embodiment, the enclosure 24 is generally concave when viewed from the top, forming a bowl-like arrangement. A volume 42 enclosed within the bowl is well suited for housing a variety of components configured to transmit data representative of at least an image to the video display 26. In one embodiment, as discussed more fully below, the volume 42 houses a DVD player 44, a digital media reader 46, and a switch assembly 48. These components may be mounted in the volume 42 of the enclosure 24 any suitable fashion. For example, a plurality of posts that extend from a bottom inside surface 50 of the volume can be formed provided. These posts can be formed during an injection molding process and thereafter, threaded bores can be formed therein, which bores are configured to receive screws that engage a part of any of the DVD player 44, for example. Any other suitable manner of securing the DVD player 44 and other components in the volume 42 may be provided.

A recess 52 formed in the bottom of the enclosure 24 is configured to receive the video display 26. When the video display 26 is in the recess 52, it may be said to be “stowed” or to be in the “stowed position.” In this position the lowest surface of the video display 26 desirably is flush with (e.g., at about the same elevation as) the bottom of the enclosure 24. This arrangement provides protection for the video display 26, which is surrounded about its periphery by at least one additional layer of the enclosure 24. The bottom surface of the enclosure 24 may also form at least a portion of or may receive a lens through which the lights 28 may shine to at least partially illuminate the passenger compartment 14. Additional light and lens combinations may be provided on the bottom surface of the enclosure 24 or any other surface of the multi-media player, e.g., to illuminate a manufacturer name or other pertinent text or symbols.

In one embodiment an aperture 54 is formed on the bottom surface of the enclosure 24 through which the multi-position switch 30 may be extended. The aperture 54 is preferably near the trailing end 34 of the enclosure 24 for more convenient manipulation by rear-seat passengers.

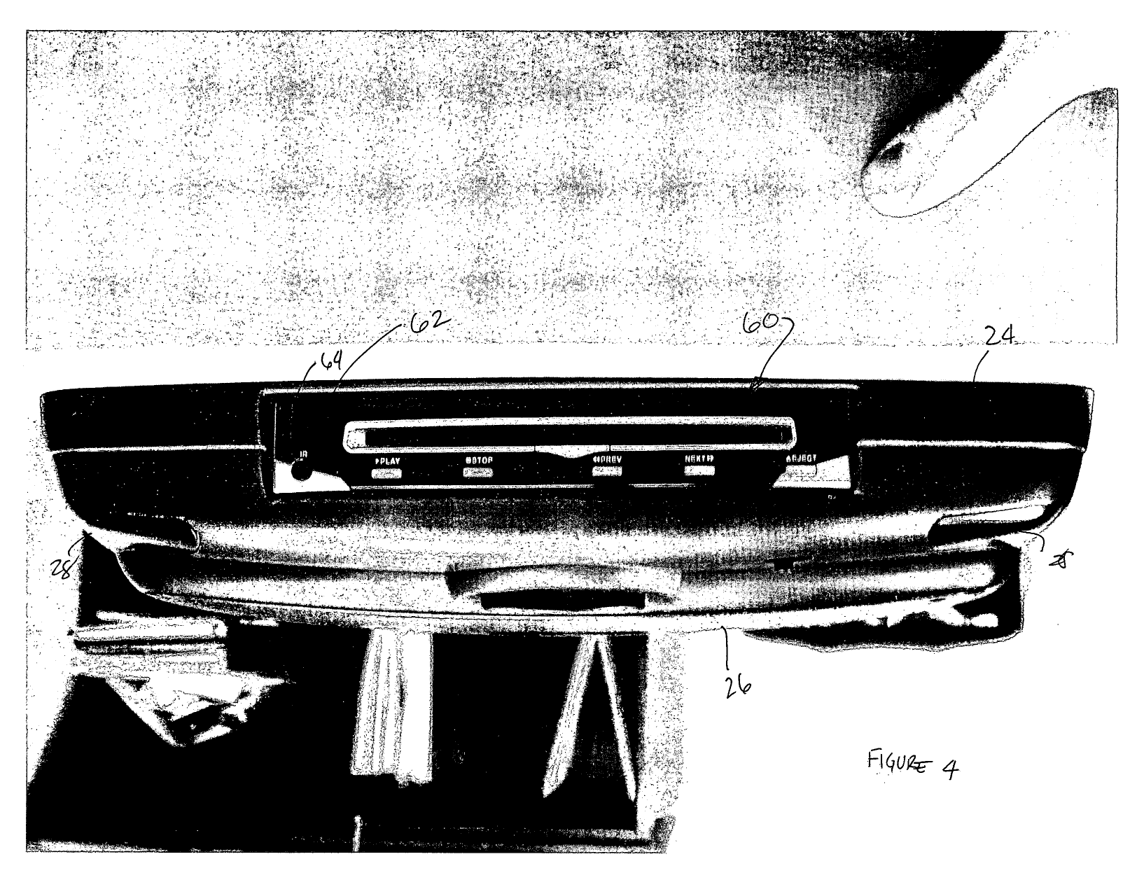

The multi-media player 22 desirably includes components that receive removable non-volatile mass storage units, e.g., units capable of retaining stored data without a supply of power, and therefore desirably is configured to provide access to such components. It may be more convenient to enable passengers and other users to insert into and remove different types of non-volatile mass storage units from such components. Where the mulit-media player 22 is intended to be mounted to the roof 20 of the car 10 in a location convenient for rear-seat passenger viewing, it may be convenient to provide rear-seat access to the components within the housing. In one embodiment, a DVD aperture 60 is provided on the trailing end 34 of the enclosure 24, as shown in FIGS. 3-5. The DVD aperture 60 may be configured in any suitable manner. Desirably, however, the DVD aperture 60 may have a height and a width sufficient to expose a face 62 of the DVD player 44, as shown. This enables a variety of finger-actuated control buttons located on the exposed face 62 to be accessible to the rear seat passengers. In the illustrated embodiment, the control buttons include a play button, a stop button, a next button, a previous button, and an eject button. Other control buttons may be provided to control other DVD player functionality.

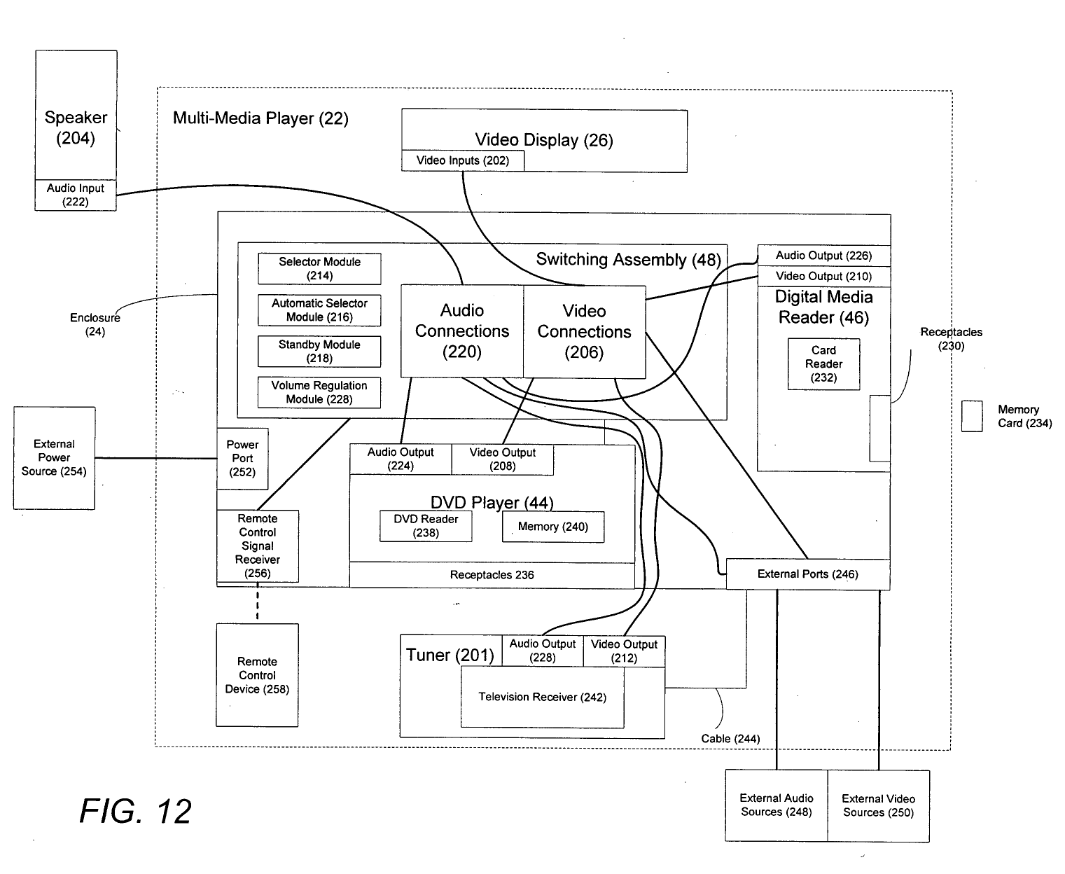

The DVD player 44 is also desirably controllable by way of a wireless remote control 258 (FIG. 12), as discussed more fully below. One suitable form of a remote control system employs a hand-held transmitter that transmits signals in the infrared (IR) electromagnetic light region and a sensor. In the illustrated embodiment an IR sensor 64 is located on the exposed face 62 of the DVD player 44. The DVD aperture 60 thus also permits IR control signals to be transmitted into the volume 42 of the enclosure 24 to control the DVD player 44. In other embodiments, control signals may be transmitted to the DVD player 44 in other manners, and thus the size of the DVD aperture 60 may be reduced as desired to about the size of a DVD.

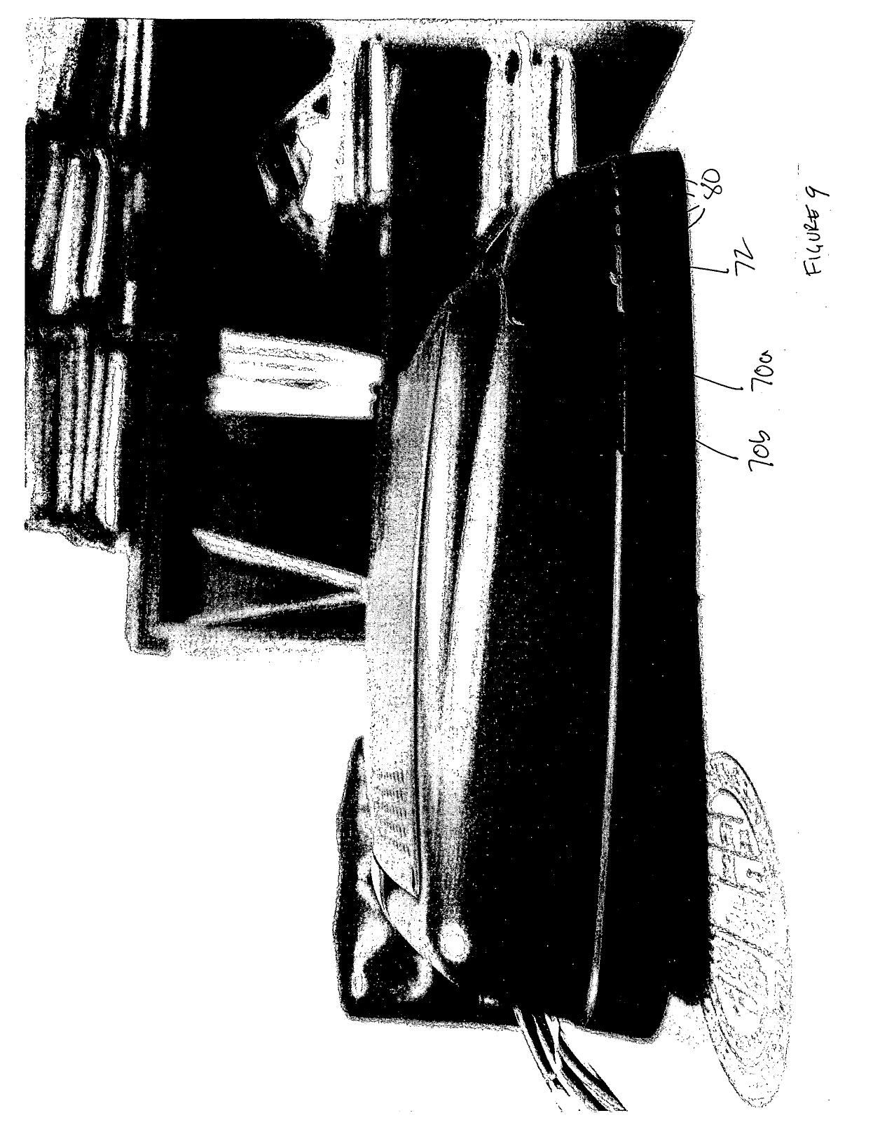

With reference to FIG. 9, a digital media reader aperture 70 may be formed in the enclosure 24 to provide access to insert non-volatile mass storage units into the digital media reader 46. As discussed below, one advantage of the multi-media player 22 is that it can receive a variety of non-volatile mass storage units, including different formats of memory cards 234 (FIG. 12). FIG. 9 shows that in one embodiment, a first digital media reader aperture 70a and a second digital media reader aperture 70b are formed in the right-facing lateral side 38 of the enclosure 24. The apertures 70a, 70b provide access to receptacles in the digital media reader 46 located within the volume 42.

One advantage of the arrangement illustrated in FIG. 9 is that each of the apertures 70a, 70b is configured to receive more than one type, e.g., two types, of non-volatile mass storage units. These different types of non-volatile mass storage units may be different formats, e.g., different arrangements thereof made by different manufacturers, as is discussed below. This provides a great deal of flexibility. For example, the multi-media player 22 can be sold to virtually all potential customers, regardless of the type of digital camera that they own. Also, a customer can switch camera and mass storage unit configurations without replacing or modifying the multi-media player 22. In addition, where multiple users are involved, different mass storage units from different cameras can be used together or separately. Thus, the multi-media player 22 is flexible for the manufacturer and the user.

In one embodiment, the digital media reader 46 has a stand-by mode, as discussed more fully below. The stand-by mode may be visually indicated by a light emitting diode (LED) 72 that extends through the right-facing lateral side 38 of the enclosure 24.

A plurality of heat transfer slots 80 may be formed on one or more surface of the enclosure. The primary function of the heat transfer slots 80 is to convey heat away from the electronic components housed within the enclosure 24.

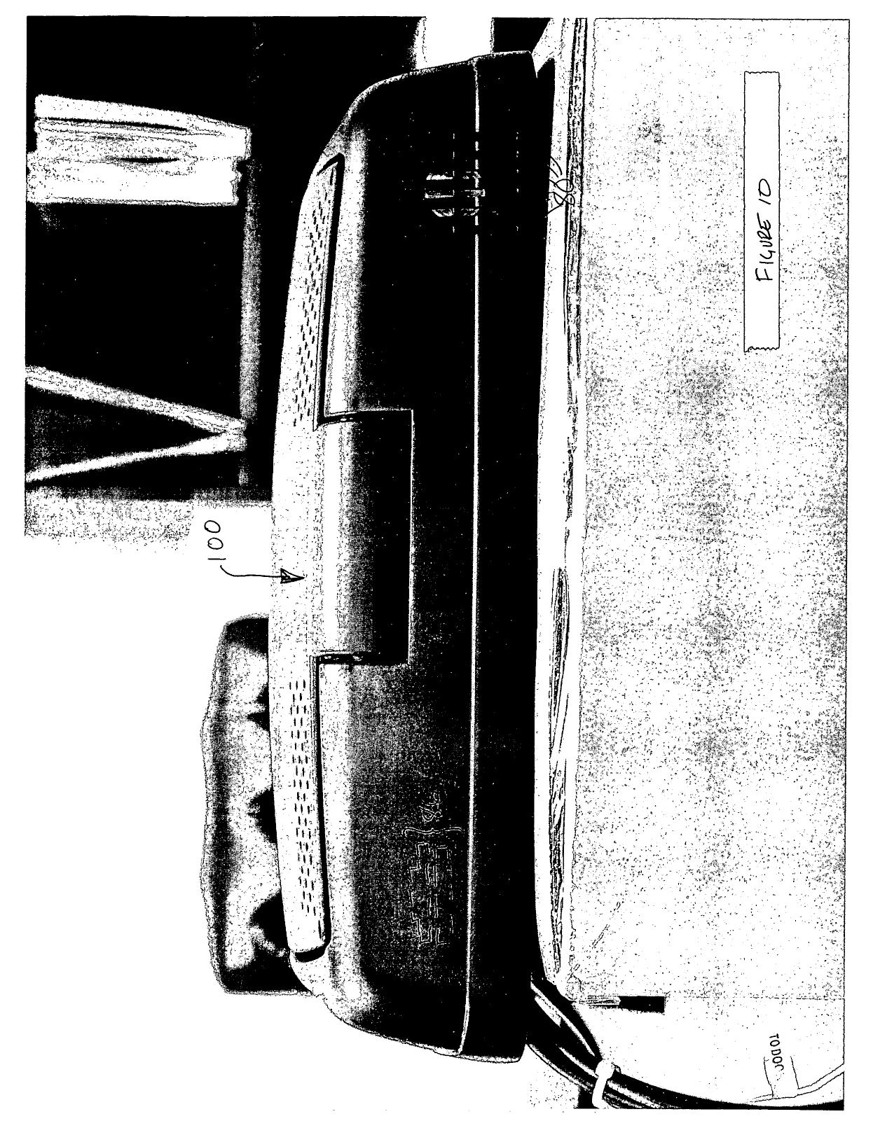

The enclosure 24 may be modified in various embodiments to enable access to the receptacles of the digital media reader 46 from different approaches. In one variation, the digital media reader 46 is oriented so that non-volatile mass storage units can be inserted from the leading end 32 of the enclosure 24. This can be accomplished by relocating mounting structures in the volume 42 and providing an aperture in the leading end 32 of the enclosure 24, as indicated in FIG. 10 by an outline 86. This arrangement is advantageous where the front seat passenger is to insert the non-volatile mass storage units into the Digital media reader 46. For example, some passengers in the rear seat, particularly children, may be too small to reach the right-facing lateral side 38 of the enclosure 24. But, a forward facing aperture, as indicated by the outline 86, could more easily be reached by a parent in a front seat.

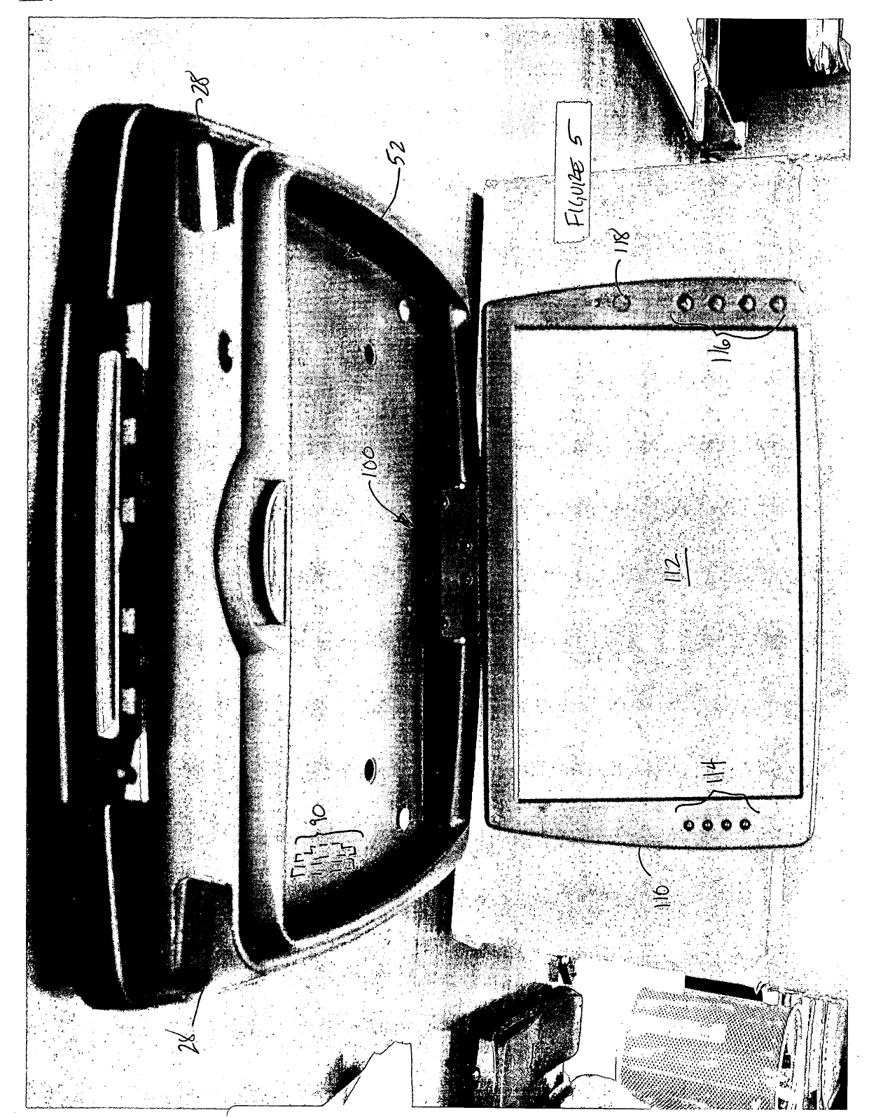

In another variation, the enclosure is modified so that non-volatile mass storage units can be inserted from the bottom of the enclosure 24. This can be accomplished by relocating mounting structures in the volume 42 and providing an aperture in the top of the recess 52 of the enclosure 24, as indicated in FIG. 5 by an outline 90. This arrangement is advantageous where other components are mounted to the roof 20 of the car 10 and the lateral sides of the enclosure 24 are not accessible. A further advantage of this arrangement is that the receptacle of the digital media reader 46 is shielded when the video display 26 is stowed within the recess 52.

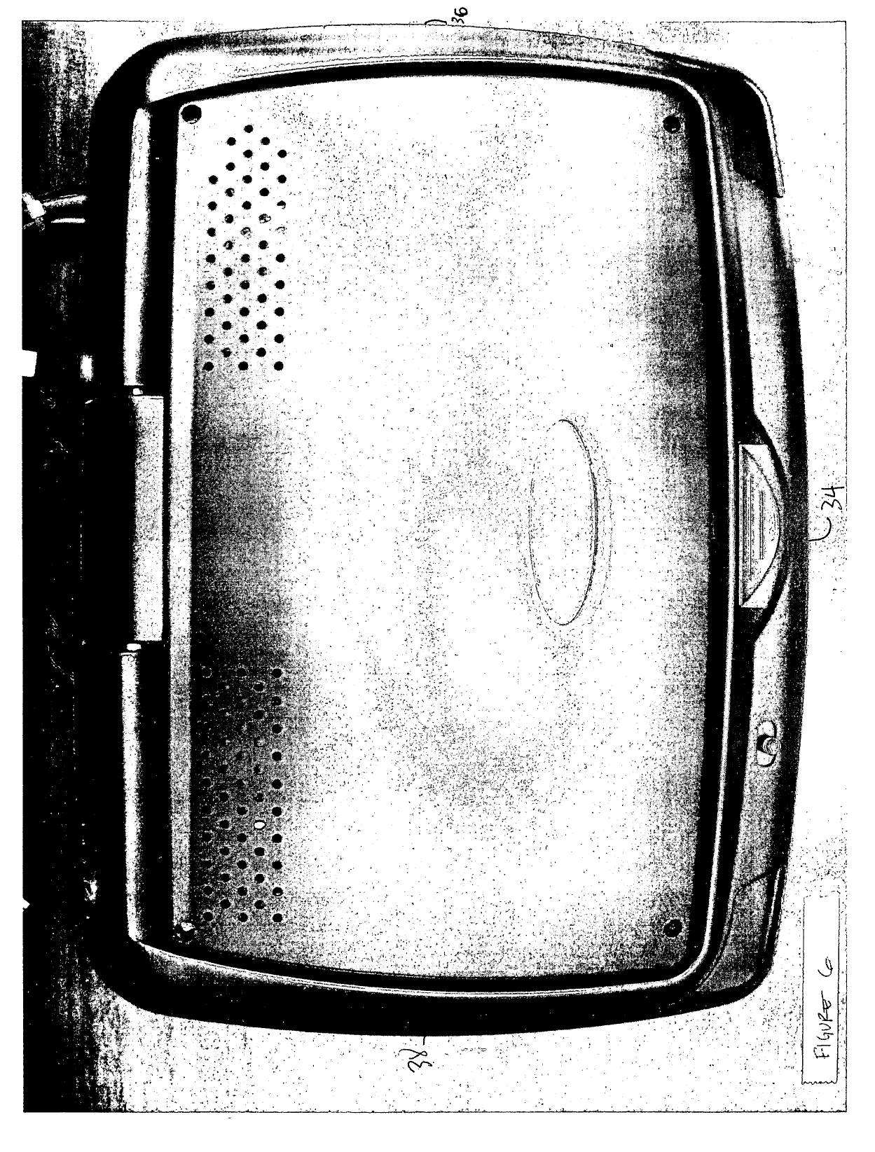

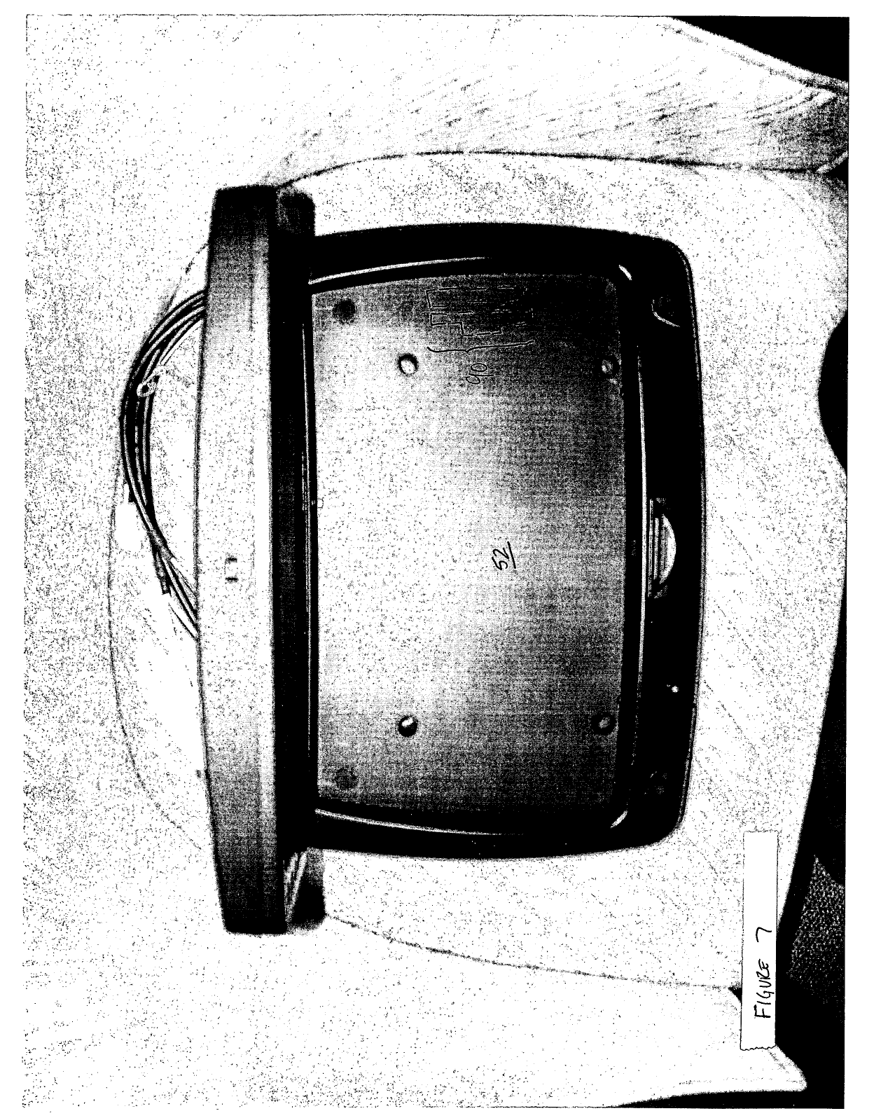

The video display 26 is coupled with the enclosure 24 in a manner that permits the video display 26 to be stowed, as discussed above and as is shown in FIGS. 3-4, 6, and 9-10 and to be deployed in a variety of positions, as is shown in FIGS. 5 and 7-8. In one embodiment, a latch mechanism is provided to maintain the video display in the stowed position. This latch mechanism may be any suitable latch mechanism, e.g., one that engages automatically when the video display is moved into the recess 52 and that is released by actuating a release button 98. With reference to FIG. 3, the release button 98 may be positioned near the trailing end 34 of the enclosure 24 in one embodiment. However, the release button can be positioned elsewhere, e.g., for convenient access by front seat passengers. The functionality of the latch mechanism can also be incorporated into the hinge assembly (discussed below) and the release button 98 can be eliminated entirely.

The capability of positioning the video display 26 in the stowed or in one of the deployed positions is provided by a hinge assembly 100 in one embodiment (shown in FIGS. 5-6, 8 and 10). The hinge assembly 100 includes first hinge portion associated with the video display 26 and a second hinge portion associated with the enclosure 24. The first and second hinge portions permit the video display 26 to be pivoted about a first axis from the stowed position to any of a variety of deployed positions. The hinge assembly 100 may be a self-tensioning hinge, e.g., one that enables the video display 26 to rotate to any selected position and to maintain the video display 26 in the selected position without any a complicated ratcheting mechanism.

In one embodiment, the range of motion of the hinge assembly 100 is greater than ninety degrees. In other words, the video display may be moved through more than ninety degrees of rotation from the stowed position to the deployed position. The hinge may also permit more than about one-hundred and thirty-five degrees of rotation from the stowed position to the deployed position. In another embodiment, the range of motion about the hinge is up to about ninety degrees. In the illustrated embodiment, the range of motion about the first axis is about one-hundred and sixty degrees, while in another embodiment, the range of motion is about one-hundred and eighty degrees.

In one embodiment, the first portion of the hinge assembly 100 comprises a cylindrical axle (not shown) the ends of which are disposed within the enclosure 24 and are configured to provide uniform resistance to rotation of the video display 26.

In one embodiment, the second hinge portion is provided to permit motion about a second axis. The second axis is generally perpendicular to the first axis. In one embodiment, the second hinge portion includes a substantially cylindrical axle (not shown) that intersects the first axle through a bore in first axle, e.g., near the center thereof. The second hinge portion is held in place in any suitable manner, e.g., with a threaded nut. The second hinge portion and the bore in the first axle are configured to provide a friction fit between the second hinge portion and the first axle. The friction fit produces substantially uniform resistance to rotation of the second hinge portion.

The arrangement of the first and second axles of the first and second hinge portions and the self-tensioning character of the hinge portions provide two important features. First, they enable the video display 26 to be positioned at a wide variety of viewing angles. The video display 26 may be rotated more than ninety degrees from the stowed position about the first axis to a deployed position. In another embodiment, the video display 26 may be rotated up to and including about one-hundred and eighty degrees about the first axis from the stowed position to a deployed position where it lies flat against the vehicle roof 20 in front of the enclosure 24. In this embodiment, the leading end 32 of the enclosure 24 is configured so as not to interfere with the one-hundred and eighty degree range of motion of the video display 26.

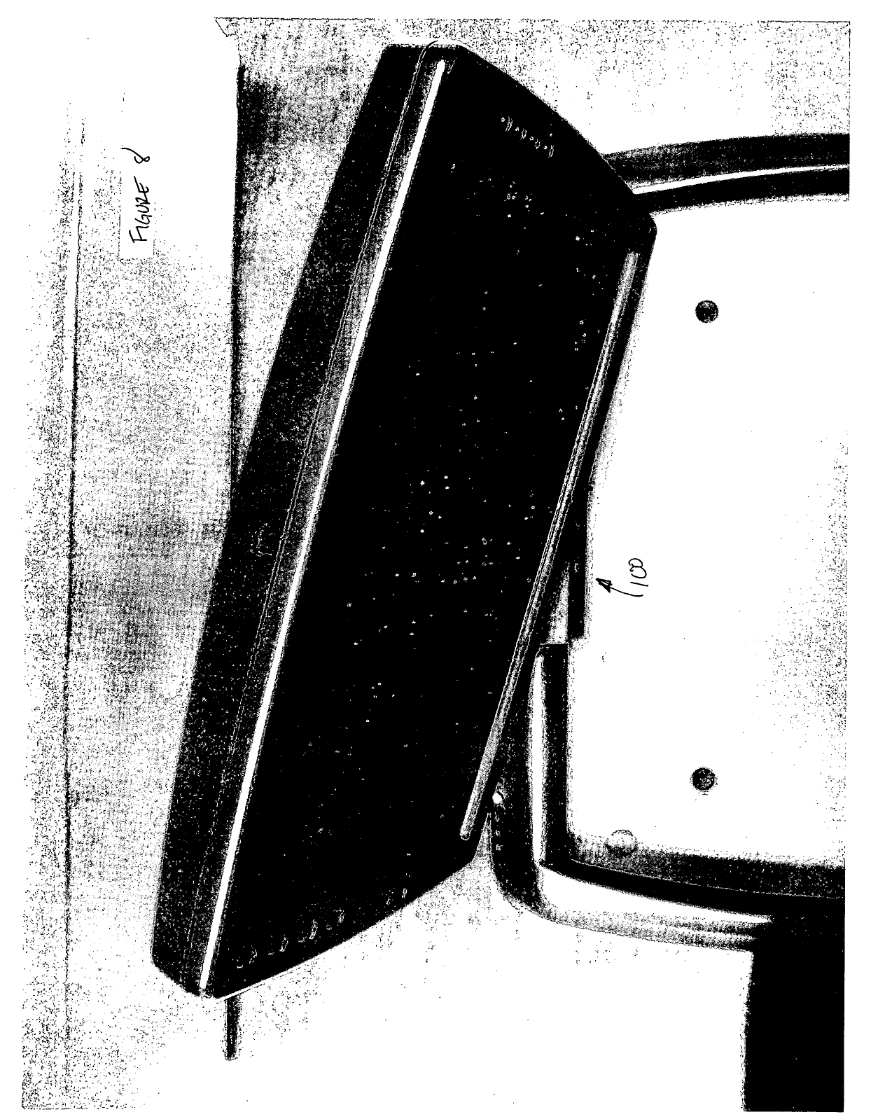

The video display 26 may also be rotated about the second axis, as shown in FIG. 8. In one embodiment, the video display 26 may be rotated at least about thirty degrees and preferably about forty-five degrees both to the right and to the left about the second axis. Positive stops within the enclosure 24 may be provided to prevent the video display 26 from being rotated any farther.

The second benefit of the foregoing configuration of the hinges assembly 100 is passenger safety. Whether a passenger is simply adjusting his position within the vehicle, or flying through the air as a result of a severe collision, any contact he makes with the video display 26 will simply push the video display 26 harmlessly out of the way. Whether the contact is made from the front or the back of the video display 26, the display 22 is able to swing toward the vehicle roof 20, or toward the enclosure 24, until it lies flat against the one or the other and poses no obstruction to passengers.

Even if the video display 26 is twisted to the left or right when the impact happens, it will still be pushed flat against the vehicle roof 20 or the enclosure 24. As the video display 26 nears the vehicle roof 20 or the enclosure 24, the force of the vehicle roof 20 or enclosure 24 upon one edge of the video display 26 will cause the video display 26 to rotate about the second axis until it aligns with the vehicle roof 20 or enclosure 24. And if a passenger contacts the video display 26 from the left or right side, the rotation of the video display 26 about the second axis will deflect the blow, resulting in little or no-harm to the passenger. Further details of the construction of the hinge assembly may be found in U.S. Pat. No. 6,409,242, issued Jun. 25, 2002, which is hereby incorporated herein by reference herein in its entirety.

Further details of the video display 26 will now be discussed in connection with FIGS. 5-8. The video display 26 includes a screen housing 110 and a video screen 112. The video screen 112 is coupled with components within the volume 42 of the enclosure 24 and receives signals therefrom in a manner described below to form images for viewing. The screen housing 110 may be made of any suitable material, preferably the same material as is used for the enclosure.

As may be seen in FIG. 5, in one embodiment, the screen housing 110 also has an audio transmitter 114 and a plurality of screen control buttons 116. The audio transmitter 114 transmits audio signals from the multi-media player 22 to a wireless receiver, such as may be incorporated into a set of wireless headphones (not shown). The audio transmitter 114 may operate on any suitable principle, e.g., IR wireless transmission. In addition, the multi-media player 22 may be configured to transmit audio signal from other components in the car 10, e.g., the car radio 18 via the transmitter 114. The screen control buttons 116 may control any aspect of screen operation, e.g., power to the screen, menu display, screen brightness, screen color, and the like. A remote control sensor 118 is preferably also located on the screen housing 110.

The video display 26 may be sized as appropriate for the circumstances. In one embodiment, the video display 26 is about 10 inches from corner to corner, more preferably about 10.2 inches. Other suitable embodiments provide different screen sizes, e.g., about a 7 inch screen or about an eight inch screen, e.g., a 7.8 inch screen.

As discussed above, the multi-media player 22 can be integrated with other components within the passenger compartment 14. For example, as discussed above, audio signals from the car radio 18 can be transmitted to headphones for private listening of one or more passengers via the transmitter 114. In addition, as discussed further below, the multi-media player 22 can be coupled with speakers 204 (FIG. 12) in the car 10 for general listening of passengers within the compartment 14. In one embodiment, the multi-media player 22 is coupled with the car radio 18 in a manner that permits audio signals from the player 22 to be transmitted to speakers 204 (FIG. 12) through the car radio 18. The multi-media player 22 may coupled with the car radio 18 by way of a wireless transmitter, may be wired to the radio, or may be wired to the speakers 204 (FIG. 12) directly, etc. The multi-media player 22 may form a part of a multi-screen system, whereby output signal lines convey signals to a second video display. The multi-media player may be configured to be coupled with additional media sources located outside of the enclosure 24, e.g., a video game console, a video cassette recorder, or other source. Further details of multiple video display and/or multiple source systems are set forth in U.S. patent application Ser. No. 10/361,897, filed Feb. 7, 2003, which is incorporated by reference herein it is entirety.

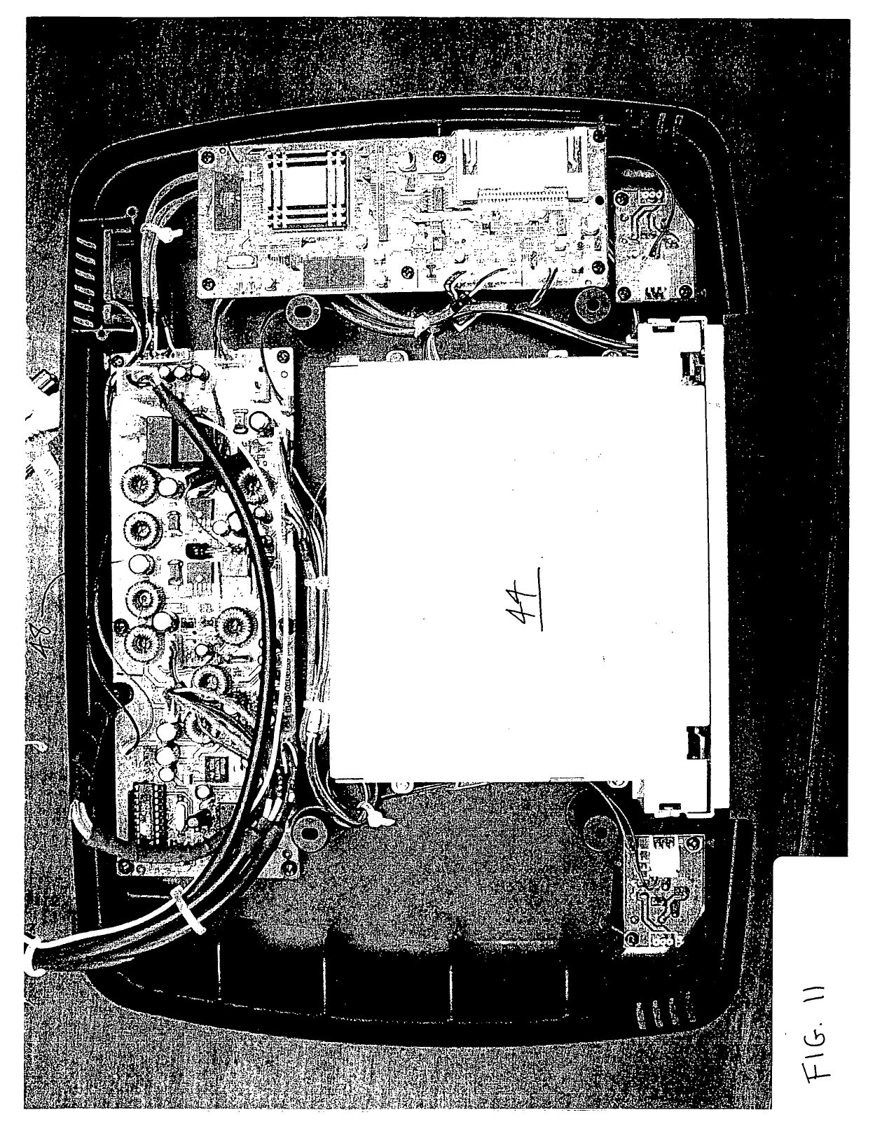

Having described the enclosure 24 and the video display 26, further details of the operation of the components housed in the volume 42 will now be discussed. FIG. 11 is an internal view of the switching assembly 48, the digital media reader 46, and the DVD player 44 within an open enclosure 24 according to an exemplary embodiment. As illustrated, the switching assembly 48, the digital media reader 46, and the DVD player 44 may be connected by a plurality of cables. A tuner 201 (FIG. 12) configured to receive television signals that is external to the enclosure 24 advantageously may be connected to the multi-media player via cable 244, wireless, or other connection, and is also in communication with the switching assembly 48. As illustrated, in one embodiment the switching assembly 48 and the digital media reader 46 have a circuit board. Additionally, though not shown, the DVD player 44 also desirably has a circuit board. As will be appreciated by a skilled artisan, television tuners 201 and circuit boards for controlling switching assemblies, digital media readers, and DVD players are generally available and provided within, for example, stand-alone televisions, stand-alone DVD players, stand-alone digital media readers, and the like. As illustrated, however, the multi-media player advantageously provides every one of a tuner 201, a digital media reader 46, and a DVD player 44 within a single enclosure 24, together with a switching assembly 48 capable of allowing a viewer to alternate in viewing video from multiple video sources. Additionally, in advantageous embodiments, the tuner 201, the digital media reader 46, and the DVD player 44 together are able to access video that is stored in a large majority of video formats presently known to a skilled artisan. Advantageous optional features of the switching assembly 48 enable an intelligent interaction between the tuner 201, the digital media reader, and the DVD player 44, such as, for example, by enabling an automatic standby mode that remembers the location within a DVD that a viewer has reached while the viewer temporarily views video from the digital media reader, then resumes playback of the DVD at the correct location when the viewer switches back. These features and others not previously available in vehicle-mountable multi-media players greatly enhance a traveler's experience.

FIG. 12 is a functional block diagram illustrating components of the multi-media player and interactions among the components that allow a viewer to view a wide-variety of video sources and formats within a vehicle. As previously described, in one embodiment, a multi-media player comprises an enclosure 24 enclosing a switching assembly 48, a DVD player 44, and a digital media reader 46, a tuner 201, and a video display 26. According to an embodiment, the video display 26 comprises one or more video inputs 202. The video inputs 202 are configured to receive video signals or other data representative of one or more images. The video inputs 202 may be configured to receive any combination of analog data, such as, for example, standard broadcast television signals, and digital data. “Digital data” is a broad term including all forms of digital data known to a skilled artisan. Exemplary digital data includes data encoded on CD-Roms, DVDs, RAM, hard disk drives, memory cards 234, and the like. Exemplary digital data also includes data formatted in any of a number of data formats, including, for example, GIF, JPEG, TIFF, QuickTime, AVI files, MPEG, WMV, and the like. The video display 26 is configured, upon receiving data on an video input 202, to display one or more images represented by the received data. The images may be still images or moving images.

According to an embodiment, the enclosure 24 encloses a switching assembly 48, a digital media reader 46, and a DVD player 44. In one embodiment, the switching assembly 48 communicates with the digital media reader 46, the DVD player 44, the video display 26, one or more speakers 204, and a tuner 201. In general, the switching assembly 48 includes a plurality of video connections 206 configured to connect video outputs 208, 210, 212 from multiple video sources with at least one video input 202 of the video display 26, such that images originating from any of the video sources may be displayed on the video display 26. As used herein, a video connection may be established using any mechanism for connecting a video output 208, 210, 212 to a video input 202, including, for example, wires, cables, analog switches, digital switches, wireless transmitters and receivers, fiber optics, any combination of the foregoing, and any other mechanism known to a skilled artisan in light of this disclosure.

Additionally, the switching assembly 48 may have a selector module 214 configured to select one or more of the video connections 206 such that a selected video connection transmits one or more images to the video display 26. Thus, the switching assembly 48 allows for the selection by, for example, a human viewer, to select which image source to view. A human viewer may, for example, switch between watching a television program, to watching a movie on a DVD, to viewing still images stored on a memory card 234, and the like. Additionally, the switching assembly 48 may have an automatic selector module 216 that makes selections without direct assistance from a human viewer, or with some assistance from a human viewer. The automatic selector module 216 may, for example, rotate among video sources based on a set schedule, randomly choose a video source, make a selection based on programmed settings, or the like. Alternatively, or additionally, a human viewer and the automatic selector module 216 may cooperate to select an image source. The foregoing selector module 214 and automatic selector module 216 may comprise one or more circuits, software executed by a CPU, firmware, any combination of the foregoing, or the like.

In one embodiment, the switching assembly 48 has a standby module 218 that, when a viewer changes video sources, keeps track of a location, in a series of images, at which the viewer is viewing information, then begins display of a series of images at substantially the same location as was previously being viewed. The standby module 218, therefore, allows a viewer, for example, to be watching a DVD, switch to watching television, and switch back to the DVD, without losing track of where, within the DVD, that the viewer left off watching. While the DVD player 44 is standing by, the switching assembly 48 connects the tuner video output 212 to the video display 26, allowing a viewer to view a television program. In one embodiment, the tuner 201 is controlled independently of the switching assembly 48, such that a viewer selects a broadcast channel using the tuner 201, and the tuner video output 212 changes according to the channel selection. In another embodiment, the switching assembly 48 has more interaction with the tuner 201, such as, for example, by instructing the tuner 201 to power down, or stand by, while a different video source has been selected. In one embodiment, a memory 240 within the DVD player 44 maintains information concerning the location that was being played at the time the DVD player 44 stands by. Advantageously, in one embodiment the multi-media player is configured to continue to supply power to the DVD player 44 while the DVD player 44 is in such standby mode to enable retention of the memory 240.

In some embodiments, the switching assembly 48 also comprises audio connections 220 configured, in a manner analogous to the foregoing video connections 206, to connect at least one audio input 222 located on at least one speaker 204 to one or more outputs located on audio sources. In one embodiment, the speaker 204 is located outside the enclosure 24. In one embodiment, the speaker 204 is not part of the multi-media player. In one embodiment, the speaker 204 may be connected to an audio system of the vehicle upon which the multi-media player is mounted. Alternatively, the speaker 204 can be part of the multi-media player and located within the enclosure 24, but desirably the speaker 204 is located outside the enclosure 24. A skilled artisan will appreciate that such audio sources may include the video sources previously described, as devices such as DVD players, digital media readers, tuners, and the like often transmit both video and audio data. As with the video connections 206, the audio connections 220 may be configured to transmit analog audio, digital audio, and any combination of the two. A skilled artisan will appreciate, in light of this disclosure, that the functions of the selector module 214, the automatic selector module 216, and the standby module 218 may be performed with regard to audio sources as with video sources. Thus, the selector module 214 and automatic selector module 216 may choose audio input 222 from a DVD player 44, a digital media reader 46, a tuner 201, or the like. The standby module 218 may allow for standby and resume of audio sources. Additionally, in one embodiment, the switching assembly 48 also comprises a volume regulation module 228. The volume regulation module 228 is configured to maintain, at a substantially constant level, the volume of any audio played by the multi-media player. The volume regulation module 228 may comprise one or more circuits, software executed by a CPU, firmware, any combination of the foregoing, or the like. In some embodiments, video connections 206 and audio connections 220 may be combined such that both video data and audio data are transmitted using a single, combined connections, such as, for example, in embodiments that use S-Video to transmit both video and audio data.

According to an embodiment, the digital media reader 46 comprises one or more receptacles 230 configured to receive memory cards 234, a card reader 232 configured to read data from memory cards 234, and a video output 210 configured to transmit data. In one embodiment, the video output 210 of the digital media reader 46 is configured to transmit video data to the video display 26 through one or more of the video connections 206 of the switching assembly 48. Additionally, the digital media reader 46 may comprise an audio output 226 likewise configured to transmit audio data to one or more audio inputs 222 of one or more speakers 204 through one or more of the audio connections 220 of the switching assembly 48. Advantageously, the digital media reader 46 may be located within the enclosure 24.

As used herein, a “memory card” 234 generally encompasses all forms of non-volatile memory 240 commonly known in the art as “flash memory.” Generally, such memory cards 234 store random access memory 240 that is readable and writable. For example, one typical use of such memory cards 234 is to store digital images taken using digital cameras. Generally, users of digital cameras are able to scroll through the images, access and view particular images, delete images, replace images with new images, and, in some cases, edit images and store edited images. Alternatively, a memory card 234 need not be random access memory, but may be configured to store non-volatile memory that is read only, or non-volatile memory that is only partially writable, such as, for example, write once, read many memory that may be written once and may be accessed many times, but may not be erased. The digital media reader 46 is configured to read both random access and read only memory cards 234. In one embodiment, the memory card may desirably comprise a “standardized memory module,” such as a CompactFlash card, a SmartMedia card, a Memory Stick card, a PCMIA type I card, a PCMIA type II card, a Secure Media card, and a Multi Media Card. Advantageously, the digital media reader 46 may have receptacles 230 configured to receive each of the foregoing memory cards 234. Alternatively, the digital media reader 46 may be configured to read one or some of the foregoing memory cards 234. Additionally, a skilled artisan will appreciate that a number of digital data formats exist for storing digital images, such as, for example, MPEG, JPEG, QuickTime, AVI, WMV, GIF, TIFF, and the like. Advantageously, the digital media reader 46 can be configured to read each of the foregoing data formats. Alternatively the digital media reader 46 can be configured to read some or one of the foregoing data formats. The foregoing lists of memory card 234 types and digital data formats are exemplary only and not limiting. A skilled artisan will appreciate, in light of this disclosure, that the digital media reader may be configured to read other types of memory cards 234 and digital data formats in accordance with the principles of this disclosure.

According to an embodiment, the DVD player 44 comprises one or more receptacles 236 configured to receive digital video discs, a DVD reader 238 configured to read data from the digital video discs, and a video output 208 configured to transmit data. In one embodiment, the video output 208 of the DVD player 44 is configured to transmit video data to the video display 26 through one or more of the video connections 206 of the switching assembly 48. Additionally, the DVD player 44 may comprise an audio output 224 that is likewise configured to transmit audio data to an audio input 222 of one or more speakers 204 through one or more of the audio connections 220 of the switching assembly 48. Advantageously, the DVD player 44 may be located within the enclosure 24.

In one embodiment, the tuner 201 comprises a television receiver 242 configured to receive standard broadcast television signals and a video output 212. In one embodiment, the tuner 201 has access to broadcast frequencies commonly available to standard television receivers 242. The video output 212 of the tuner 201 is configured to transmit video data to the video input 202 of the video display 26 through one or more of the video connections 206 of the switching assembly 48. Additionally, the tuner 201 may comprise an audio output 228 that is likewise configured to transmit audio data to an audio input 222 of one or more speakers 204 through one or more of the audio connections 220 of the switching assembly 48. Thus, the tuner 201 enables a viewer to select a broadcast channel and view television programs on the video display 26. In one embodiment, the tuner 201 is located outside the enclosure 24 and is connected to one or more external ports 246 via cable 244. In turn, the external ports 246 are connected to the switching assembly 48, thus connecting the tuner 201 with one or more of the video connections 206. Alternatively or additionally, the tuner 201 may be connected via a wireless connection. The tuner 201 may also be located within the enclosure 24 and connected directly to one or more of the video connections 206.

In one embodiment, the multi-media player also comprises a plurality of external ports 246 configured to be connected, via wire, cable 244, wireless receiver, or otherwise, to one or more external video sources 250 and one or more external audio sources 248. The external power ports 252 may in turn be connected to the video and audio connections 220 of the switching assembly 48, such that the external video sources 250 and the external audio sources 248 may be selectably connected to the video inputs 202 of the video display 26 and the audio inputs 222 of the speakers 204, respectively. In this fashion, the multi-media player may advantageously be expanded to connect more video sources and audio sources than those provided with the multi-media player. Such additional video sources and audio sources may include, for example, VCRs, CD players, MP3 players, Camcorders, digital cameras, radio tuners 201, external DVD players 44, external digital media readers 46, and the like.

In one embodiment, the multi-media player also comprises a power port 252 configured to receive power from an external power source 254. In one embodiment, the power port 252 is configured to receive power from a 12 volt battery. Additionally or alternatively, the power port 252 may be configured to receive power from an electrical system of a vehicle to which the multi-media player is mounted.

In one embodiment, the multi-media player also comprises a remote control signal receiver 256. The remote control signal receiver 256 receives signals from a remote control device 258 that direct the operation of the multi-media player. In one embodiment, the remote control 258 communicates with the remote control signal receiver 256 using infrared signals. Various functions are provided on the remote control 258, such as, for example, change video source, change audio source, fast forward, reverse, change channel on the tuner 201, advance an image on the digital media reader 46, and the like. A skilled artisan will appreciate, in light of this disclosure, that there exist a large number of commonly used remote control commands that can be incorporated into the remote control 258. In one embodiment, the remote control signal receiver 256 is in communication with any component of the multi-media player configured to be controlled by the remote control 258. For example, the remote control signal receiver 256 may be in communication with the switching assembly 48 such that the remote control 258 is able to control which video source and audio source is selected by the selector module 214 and the automatic selector module 216. Additionally, the remote control signal receiver 256 may be in communication with the digital media reader 46, the DVD player 44, and the tuner 201 for purposes of controlling the foregoing devices. Alternatively or additionally, the remote control 258 may communicate directly with the digital media reader 46, the DVD player 44, or both.

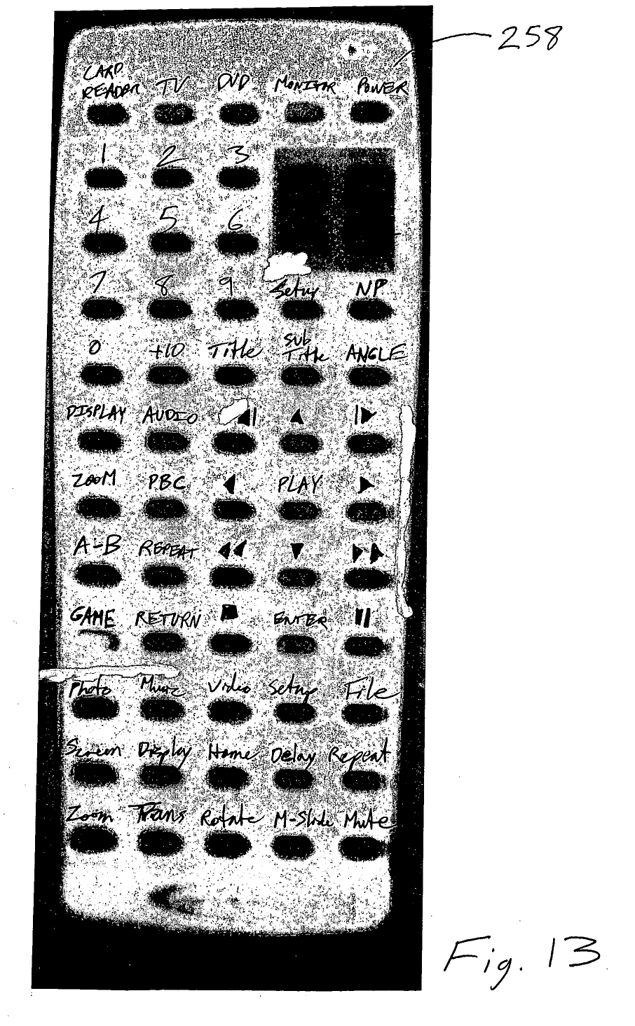

FIG. 13 is an illustration of one embodiment of a remote control 258 for transmitting commands to the audio and video sources connected to the switching assembly. A skilled artisan will appreciate, from the labels of buttons on the remote control 258, various features known within the art. For example, the remote control 258 has a play button, fast forward, reverse, step back, step forward, directional arrows for making selections, such as, for example from menus, buttons for selecting audio and video sources, such as, for example, “Card Reader,” “TV,” “DVD,” “MONITOR,” and the like. Additionally, the remote control 258 may have number buttons from 0 to 9 for entering channel numbers, track numbers, chapter numbers, other numbers, and the like. The remote control 258 also may have a +10 button for rapidly advancing 10 channels, tracks, chapters, and the like. A setup button may invoke a setup menu. A N/P button may toggle between NTSC and PAL video formats. A Title button may return to a title screen, such as in a DVD. A Subtitle may turn subtitles on or off, or switch among languages of subtitles, such as, for example, switching between Spanish, French, and German subtitles, and the like. An angle button may allow a viewer to view different camera angles.

In one embodiment, a PBC button invokes a playback control mode. In one embodiment, when playback control is on, when new media, such as a DVD is inserted, a viewer is only presented with a title of the media to be played, and must push, for example, the play button to start viewing the media. Additionally, when playback control mode is on, fast forward, reverse, and similar controls may be activated. When playback control is off, controls such as fast forward and reverse may be disabled, such that a viewer can only watch any media straight through without intervention. In such a mode, when new media is inserted, it may automatically begin playing without viewer intervention. Alternatively, when play back control mode is off, some but not all controls may be disabled.

In one embodiment, an A-B button allows a viewer to mark media at two locations, an A location and a B location. Then, the segment of media between the marked locations may be repeated over and over again. Alternatively, the segment between the marked locations may be repeated once, or a specified number of times. In one embodiment, a “File” button allows a viewer to see a listing, such as a directory listing, of the contents of a memory card. A transition button allows a viewer to change transitions between images, such as in a slide show, such as providing fade out transitions and the like. A “Rotate” button allows a viewer to rotate an image a number of degrees, such as, for example, 90 degrees, 180 degrees, and th like. The remote control 258 provides other functions that will be understood by a skilled artisan from the labels provided for the buttons. A skilled artisan will appreciate, in light of this disclosure, that some of the functions may be used on certain devices but not others. For example, in one embodiment, the features on the bottom three rows are useful only for the digital media reader.

While embodiments of the multi-media player have been described herein, this disclosure does not define the invention. A skilled artisan will appreciate many other alternative embodiments and how to make and practice them in light of this disclosure. Such embodiments are intended to be encompassed within this disclosure. The claims alone define the invention.

1. A multi-media player capable of being mounted within a vehicle, comprising:
an enclosure comprising a mounting surface configured to be mounted on an inside surface of a vehicle and an opposing surface located on an opposite side to the mounting surface;
a video display configured to receive data on at least one video input and to display images represented by the received data;
a digital media reader comprising a receptacle configured to receive a memory card, a card reader configured to read digital data representative of at least an image from the received memory card, and at least a first video output configured to transmit such read digital data, wherein the digital media reader is located substantially within the enclosure;
a DVD player comprising a receptacle configured to receive a digital video disc, a DVD reader configured to read digital data representative of at least an image from the digital video disc, and at least a second video output configured to transmit such read digital data, wherein the DVD player is located substantially within the enclosure;
a tuner comprising a television receiver configured to receive data representative of at least an image encoded within a selected broadcast video signal and at least a third video output configured to transmit such received data; and
a switch assembly comprising a plurality of video connections between the plurality of video inputs and the first video output, the second video output, and the third video output, and a selector module configured to select at least one of the plurality of video connections to transmit at least an image to the video display.

2. The multi-media player of claim 1, wherein the receptacle of the DVD player comprises a slot.

3. The multi-media player of claim 1, wherein the receptacle of the DVD player comprises a clam-shell enclosure.

4. The multi-media player of claim 1, wherein the switching assembly further comprises a plurality of audio connections configured to transmit audio between at least one audio input on at least one speaker configured to play the audio and a first audio output on the digital media reader, a second audio output on the DVD player, and a third audio output on the tuner, and the selector module is further configured to select at least one of the plurality of audio connections to transmit audio to the speaker.

5. The multi-media player of claim 1, wherein the video display is substantially flat and connected to the enclosure by a hinge such that the video display is selectably positionable in a first position with a viewable surface of the video display substantially parallel with and flat against the opposing surface such that, in the first position, the viewable surface of the video display is hidden from view and a second position in which the viewable surface of the video display is transverse to the opposing surface such that, in the second position, the viewable surface of the video display is viewable.

6. The multi-media player of claim 4, further comprising a volume regulation module configured to cause the speaker to play audio at a substantially constant volume despite differences in volume among audio outputs.

7. The multi-media player of claim 4, wherein the audio inputs are configured to transmit audio to at least one speaker outside the enclosure.

8. The multi-media player of claim 7, wherein the audio inputs are configured to transmit audio to at least one speaker connected to an audio system of the vehicle to which the multi-media player has been mounted.

9. The multi-media player of claim 6, further comprising a standby module configured such that, when the multi-media player displays a series of images from a first video source, then interrupts the display of the series of images from the first video source by displaying at least one image from a second video source, then returns to display the series of images from the first video source, the standby module causes the multi-media player to resume displaying the series of images at substantially the location at which the display of the series of images was interrupted.

10. The multi-media player of claim 9, further comprising a remote control signal receiver configured to receive control signals from a remote control, and wherein at least some multi-media player functions are controllable by the remote control.

11. The multi-media player of claim 10, wherein the remote control signal receiver is configured to receive infrared signals.

12. The multi-media player of claim 1, further comprising a power connection configured to receive power.

13. The multi-media player of claim 12, wherein the power connection is configured to receive power from a 12 volt battery.

14. The multi-media player of claim 12, wherein the power connection is configured to receive power from an electrical system of the vehicle upon which the multi-media player is mounted.

15. The multi-media player of claim 12, wherein the video display is substantially flat and connected to the enclosure by a hinge such that the video display is selectably positionable in a first position with a viewable surface of the video display substantially parallel with and flat against the opposing surface such that, in the first position, the viewable surface of the video display is hidden from view and a second position in which the viewable surface of the video display is transverse to the opposing surface such that, in the second position, the viewable surface of the video display is viewable.

16. The multi-media player of claim 15, wherein the mounting surface is configured to be mountable on an inside roof surface of the vehicle and wherein, when the mounting surface is so mounted and the video display is in the second position, an image displayed on the video display is transverse to the viewing surface.
